(19) United States
(12) Patent Application Publication
(10) Pub. No.: US 2011/0066550 A1
(43) Pub. Date: Mar. 17, 2011

(54) SYSTEM AND METHOD FOR A SECURE FUNDS TRANSFER

(76) Inventors: Clinton L. Shank, Dallas, TX (US); Mark A. Brousseau, York, PA (US)

(21) Appl. No.: 12/560,750

(22) Filed: Sep. 16, 2009

(51) Int. Cl. G06Q 40/00; G06Q 20/00; G01C 21/00; H04B 7/00; H04B 5/00; H04W 4/00

(52) U.S. Cl. 705/43; 705/44; 701/300; 701/213; 455/41.2; 455/41.1; 455/466

(57) ABSTRACT

According to one embodiment, a gateway receives a transaction from a first device in local communication with a second device. The transaction includes a payment amount and a plurality of authorization codes. The gateway uses the authorization codes to authorize the transaction and to determine an account for each device. The gateway then instructs an account manager to withdraw the payment amount from the account of the first device and to deposit it into the account of the second device. A result is received at the gateway, and the gateway sends the result to each device.

### TECHNICAL FIELD

This disclosure relates generally to funds transfers, and more particularly to a system and method for a secure funds transfer.

### BACKGROUND

A payer may transfer funds to a biller using a traditional payment instrument, such as cash, a check, or a credit card. These payment instruments, however, may be vulnerable to loss or theft. Additionally, an unauthorized user may easily obtain the account numbers of checks and credit cards and may use the account numbers to access the funds.

Mobile phone payment systems may use bank web pages or text messages, and may provide an alternative to traditional payment instruments. These systems, however, may fail to adequately secure funds transfers. Accordingly, these systems may limit the functionality available to a user and/or the dollar amount that may be transferred in order to minimize the affects of fraud.

### SUMMARY

According to one embodiment, a gateway receives a transaction from a first device in local communication with a second device. The transaction includes a payment amount and a plurality of authorization codes. The gateway uses the authorization codes to authorize the transaction and to determine an account for each device. The gateway then instructs an account manager to withdraw the payment amount from the account of the first device and to deposit it into the account of the second device. A result is received at the gateway, and the gateway sends the result to each device.

Certain embodiments of the invention may provide one or more technical advantages. A technical advantage of one embodiment may be that the security of funds transfers may be increased and vulnerabilities to fraud may be decreased. As an example, payees may be created dynamically and discarded after a single transaction, and payments may be made without transmitting certain confidential information, such as account numbers. As another example, funds transfers may require paying and billing devices to be in close proximity. In some embodiments, the proximity requirement may be enforced by comparing the location coordinates of the devices. Another technical advantage may be that transaction times may be improved over paper checks by instructing a bank to transfer funds at approximately the time the device requests the funds transfer. Additionally, an account balance may be verified at approximately the time the device requests the funds transfer to ensure that a paying account contains sufficient funds to complete the transaction. As yet another example, the secure funds transfer may transact payments and record the payments electronically, and may therefore reduce the paper usage required by paper checks and paper records systems. Decreasing fraud, ensuring the availability of funds, and reducing paper usage may allow for transactions costs to be reduced.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

A more complete understanding of embodiments of the disclosure will be apparent from the detailed description taken in conjunction with the accompanying drawings in which:

FIG. 1 illustrates an example of a network for transacting a secure funds transfer;

FIG. 2 illustrates an example of a node for transacting a secure funds transfer;

FIGS. 3A-3G illustrate an example method for setting up a device to securely transfer funds using the gateway of FIG. 1;

FIGS. 4A-4F illustrate an example method for transacting a secure funds transfer;

FIGS. 5A-5B illustrate an example of an archive for tracking completed secure funds transfers;

FIG. 6 illustrates an example of a secure funds transfer that may be completed by the paying device alone; and

FIG. 7 illustrates an example of an ATM interface for transacting a secure funds transfer.

### DETAILED DESCRIPTION

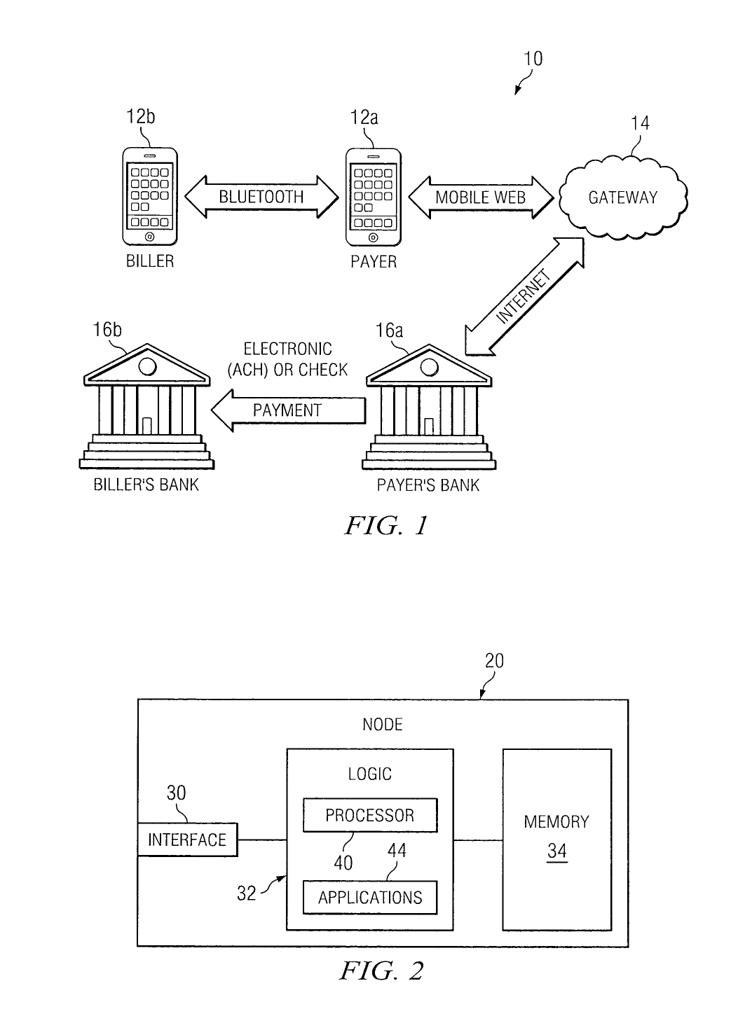

Embodiments of the present invention and its advantages are best understood by referring to FIGS. 1 through 7 of the drawings, like numerals being used for like and corresponding parts of the various drawings.

In some embodiments, a payment may be transferred between devices, such as mobile phones, using a secure funds transfer. The secure funds transfer may ensure that each device is authorized to access the bank accounts selected for making and receiving the payment. The secure funds transfer may be transacted by individuals, small businesses, such as lawn businesses or babysitters, merchants, such as grocers, gas stations, or dry cleaners, and/or other suitable parties. The funds may be transferred for any suitable purpose, including paying rent, purchasing dinner, or receiving an income tax loan. In some embodiments, the secure funds transfer may reduce the costs, fraud risks, and time requirements of funds transfers. For example, funds may be transferred approximately in real-time such that a bank receives instructions to perform a funds transfer within approximately a few minutes of a user requesting the funds transfer. In some embodiments, funds may be transferred between users who are not already signed up with the same bank or credit card company, thereby allowing for convenient access to funds.

FIG. 1 illustrates an example of a network 10 for transacting a secure funds transfer. In some embodiments, network 10 may comprise a plurality of nodes. A node may comprise an interface, logic, and memory, such as the node 20 described in FIG. 2 below. Examples of the nodes of the network 10 may include one or more devices 12, a gateway 14, and one or more account managers 16. In some embodiments, the gateway 14 may authorize a device 12 to initiate a function. For example, the gateway 14 may receive a number of authorization factors describing the device 12, authorize the device 12 according to the authorization factors, and instruct the account manager 16 to perform the function if the authorization is successful. In some embodiments, the function may comprise a funds transfer and the authorization factors may include a transaction indicating a payment amount and a plurality of authorization codes for authorizing one or more devices 12.

The device 12 may comprise any device requiring authorization to initiate a function. In some embodiments, the device 12 may be a mobile device, such as a mobile phone, a Personal Digital Assistant (PDA), or a laptop computer. In some embodiments, the device 12 may be configured to determine its current location. For example, the device 12 may include a Global Positioning System (GPS) receiver operable to determine its latitude and longitude coordinates according to a signal received from a GPS transmitter, such as a satellite system, or other device suitable to establish geographic location.

In some embodiments, the device 12 may be configured to communicate locally with another device 12. Local communication may be characterized by communication that may not extend beyond a specified radius, such as less than 100 feet or, for example, less than 25 feet. The local communication may be through a physical connection, such as a wire or cable, or a wireless connection, such as a short-range wireless communication protocol. Examples of short-range wireless communication protocols include BLUETOOTH and Near Field Communication (NFC). In some embodiments, short-range wireless transmissions may comprise radio transmissions, infrared transmissions, or any other short-range transmissions. In some embodiments, the short-range wireless communication protocol may be configured for a high level of security.

In some embodiments, the network 10 may include a paying device 12a and a billing device 12b. The billing device 12b may be a mobile device as described above or a stationary device, such as an Automatic Teller Machine (ATM) or a payment terminal at a store. The paying device 12a and the billing device 12b may establish a local communication session to generate a transaction. The devices 12 may exchange terms of the transaction, such as a payment amount, the account from which funds will be withdrawn, and the account to which the funds will be deposited. Upon a determination that the transaction terms are complete, the paying device 12a may send the transaction to the gateway 14.

In some embodiments, the gateway 14 may be a node, such as a computer, or a number of nodes, such as a network, for controlling access to other nodes of the network 10. For example, the gateway 14 may control access by authorizing the device 12 to initiate a requested function. In some embodiments, the authorization may be determined according to a plurality of authorization factors. If the authorization succeeds, the gateway 14 may instruct other nodes of network 10 to perform the function requested by the device 12. If the authorization fails, the gateway 14 may not initiate the function requested by the device 12.

In some embodiments, the authorization factors may include the GPS coordinates of the device(s) 12 being authorized. The GPS coordinates of each device 12 may be compared to the GPS coordinates of the device's expected location to verify that the coordinates substantially match. As an example, the expected location of a device 12 may be a home address or a business address indicated by a user profile associated with the device 12. As another example, the expected location of the paying device 12a may be proximate to the current location of the billing device 12b. The coordinates may substantially match if they are within close proximity to one another, such as less than 100 feet or, for example less than 2 feet. A known margin of error of the location technology may be considered in determining whether the coordinates substantially match.

In some embodiments, the gateway 14 may instruct an account manager 16 to perform an authorized function. In some embodiments, the account manager 16 may be a computer or a computer network configured to perform a function, for example, to manage the funds of an account. Examples of accounts may include savings accounts, checking accounts, credit card accounts, debit card accounts, stored value cards, lines of credit, mobile credit accounts, and/or any other suitable account. Accounts may be located anywhere in the world and are independent of the location of the device. The account manager 16 may be administered by an entity, such as a bank or a credit card company associated with the account.

In some embodiments, the gateway 14 may receive a transaction from the paying device 12a requesting to transfer funds from a payer's account managed by a payer's account manager 16a. The device 12a may request that the funds be transferred to a biller's account managed by a biller's account manager 16b. The account managers 16 may or may not be administered by the same entity depending on whether the payer and the biller hold accounts with the same entity (e.g., the same bank). The gateway 14 may authorize the transaction and may instruct the payer's account manager 16a to transfer the funds. The payer's account manager 16a may transfer the funds using any suitable method, such as an Electronic Funds Transfer (EFT), for example, an Automated Clearing House (ACH) transfer, or a check. The payer's account manager 16a may transfer funds directly to the biller's account manager 16b, or may transfer the funds via an intermediary such as the gateway 14. The payer's account manager 16a may then return a result to the gateway indicating whether the transfer was successful or unsuccessful. Example causes of an unsuccessful result may include insufficient funds in the payer's account, failure to receive a correct bank password, or network error.

The nodes of network 10 may communicate using any suitable network configuration. Examples may include, but are not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding. In some embodiments, the gateway 14 may communicate with a device 12 using a browser-based mobile web service, and the gateway 14 may communicate with an account manager 16 using the internet.

Modifications, additions, or omissions may be made to systems described herein without departing from the scope of the invention. The components of the systems may be integrated or separated. Moreover, the operations of the systems may be performed by more, fewer, or other components. For example, in some embodiments, certain messages may be communicated directly between the gateway 14 and the billing device 12b and/or the gateway 14 and the biller's account manager 16b. Operations of the systems may be performed using any suitable logic comprising software, hardware, and/or other logic. As used in this document, “each” refers to each member of a set or each member of a subset of a set.

FIG. 2 illustrates an example of a node 20 for transacting a secure funds transfer. In certain embodiments, the node 20 may comprise a device, a gateway, or an account manager, such as the device 12, the gateway 14, or the account manager 16 of FIG. 1.

In certain embodiments, node 20 may include an interface 30, logic 32, memory 34, and/or other suitable elements. Interface 30 receives input, sends output, processes the input and/or output, and/or performs other suitable operations. In certain embodiments, an interface 30 of gateway 14 receives one or more authorization factors for authorizing a function and outputs an instruction to perform the authorized function. Interface 30 may comprise hardware and/or software.

Logic 32 performs the operations of the component, for example, executes instructions to generate output from input. In certain embodiments, logic 32 of gateway 14 may authorize a function, such as a funds transfer, according to the authorization factors, such as a plurality of authorization codes (e.g., security keys). In some embodiments, the authorization codes may be configured to represent confidential information. Examples of confidential information may include a user name or an account number for a bank account. As an example, a transaction may be requested for an account number “12345678.” Logic 32 may generate an authorization code, such as “22B7465Z,” to represent the account number. Authorization codes may include any suitable number of bytes and any suitable characters. In some embodiments, the authorization code may be valid for a single transaction. The authorization code may be deleted after the single transaction and an updated authorization code may be generated for a next transaction. In some embodiments, the authorization codes may be encrypted prior to transmission from a first node 20 and decrypted upon receipt at a second node 20. In some embodiments, separate account authorization codes may be generated for each account of a particular device.

Logic 32 may include hardware (such as a processor 40), software (such as applications 44), and/or other logic. Logic 32 may be encoded in one or more tangible media and may perform operations when executed by a computer. Certain logic 32, such as a processor 40, may manage the operation of a component. Examples of a processor 40 include one or more computers, one or more microprocessors, one or more applications, and/or other logic.

In particular embodiments, the operations of the embodiments may be performed by one or more computer readable media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

Memory 34 stores information. Memory 34 may comprise one or more tangible, computer-readable, and/or computer-executable storage medium, and may exclude signals or carrier waves. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Modifications, additions, or omissions may be made to node 20 without departing from the scope of the invention. The components of node 20 may be integrated or separated. Moreover, the operations of node 20 may be performed by more, fewer, or other components. Additionally, operations of node 20 may be performed using any suitable logic comprising software, hardware, and/or other logic.

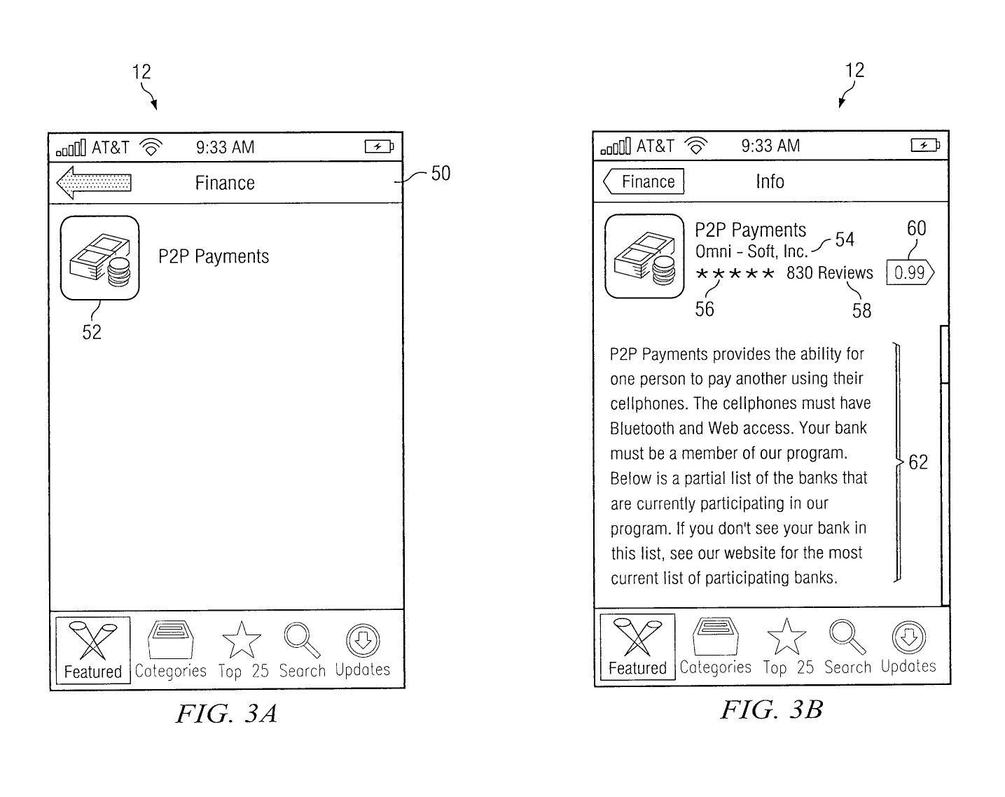

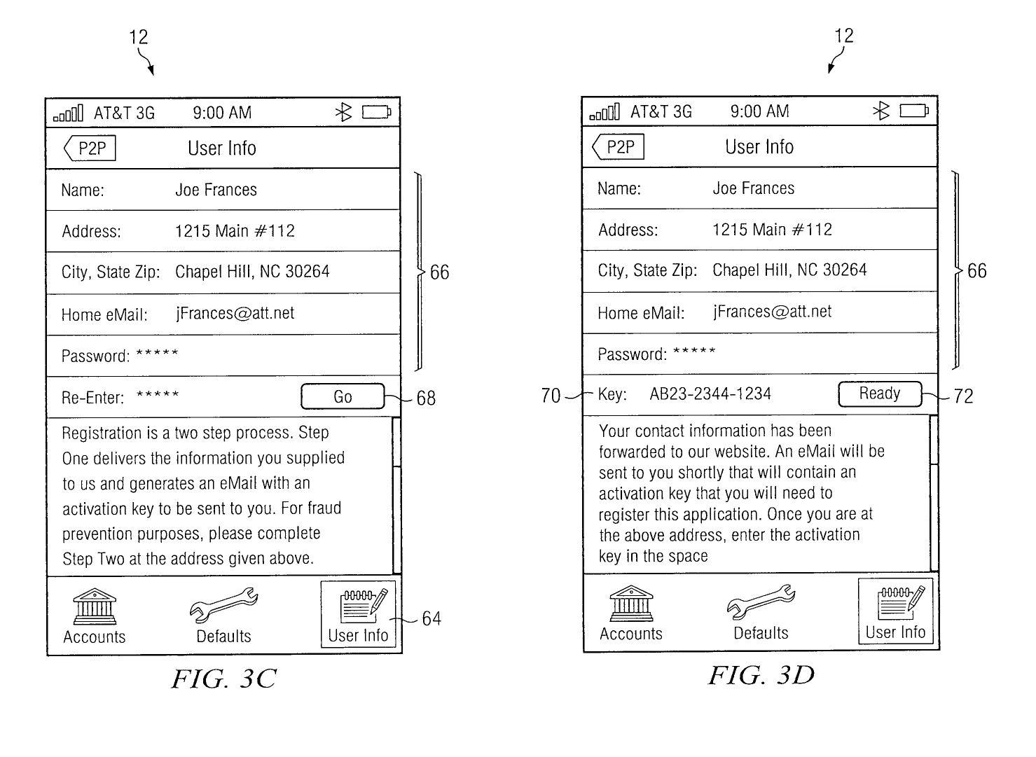

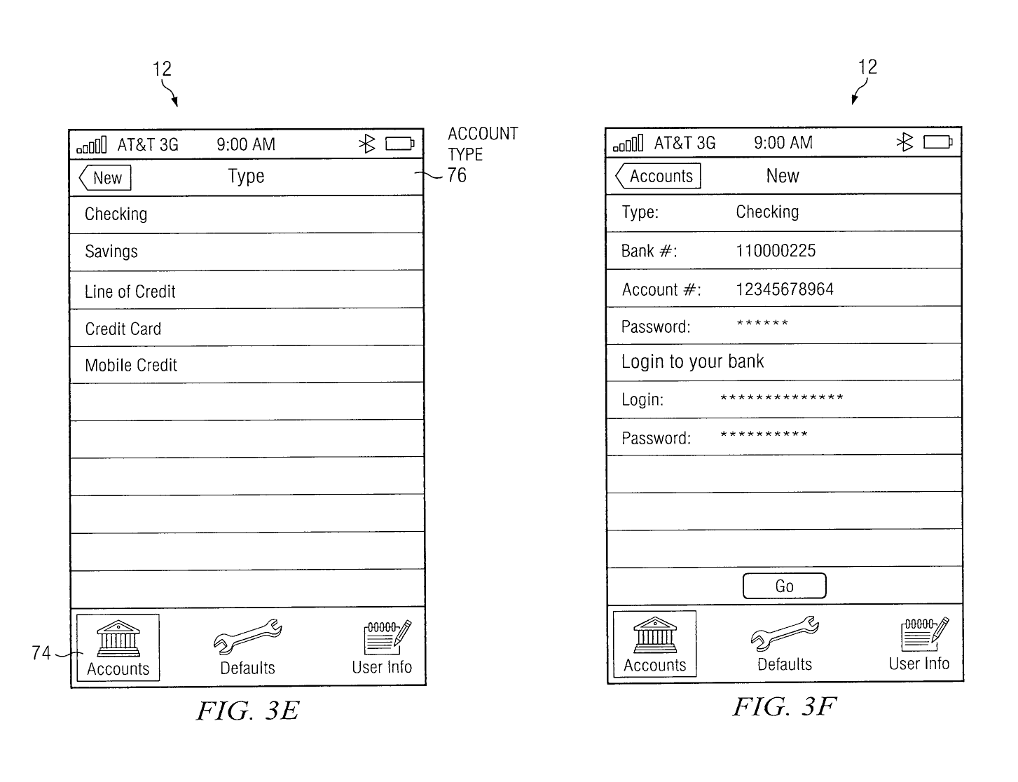

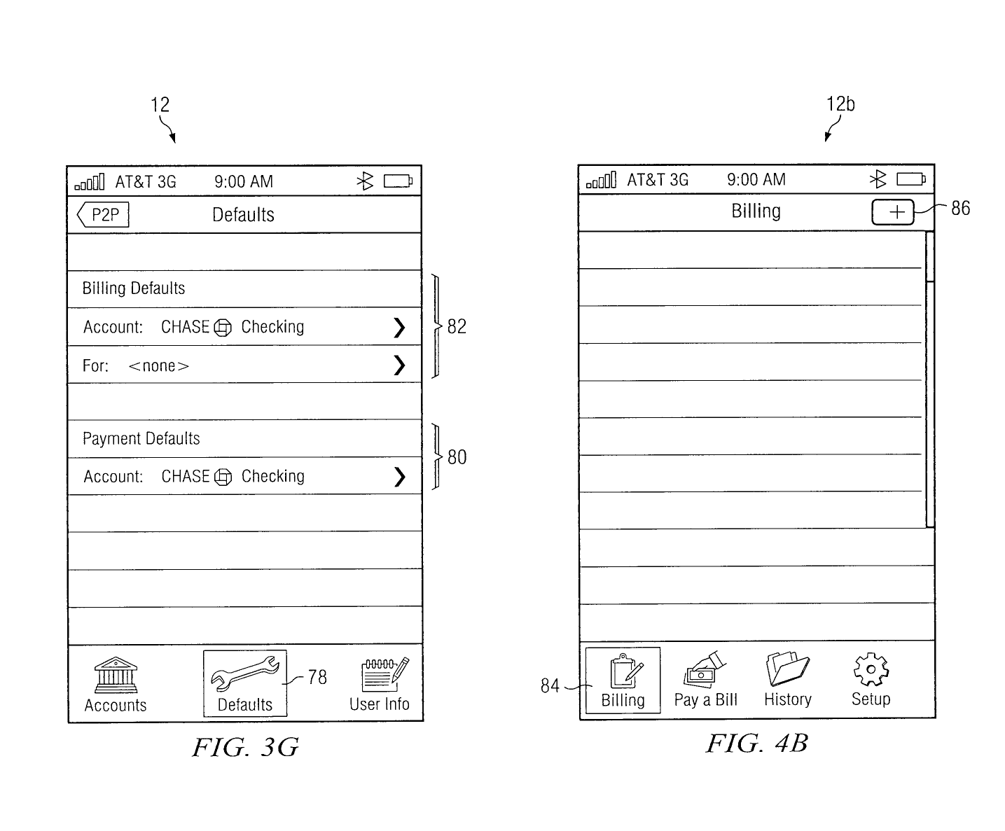

FIGS. 3A-3G illustrate an example method for setting up a device 12 to securely transfer funds using the gateway 14 of FIG. 1. Setting up the device 12 may include registering and activating a user profile. The registration and activation may utilize one or more security checks. Accordingly, in some embodiments, setting up the device 12 may be required prior to conducting the first funds transfer.

In some embodiments, the method begins with a user downloading a funds transfer application to the device. The application may be downloaded from any suitable source, such as a bank's website, an email attachment, or an application store of a software provider. The application store may include a list of available applications sorted according to newness, popularity, interest (e.g., finance), or any other suitable category. FIG. 3A illustrates an example of a finance category 50 that includes a Peer-to-Peer (P2P) Payment application 52. The user may select the P2P Payment application 52 for more information. FIG. 3B illustrates sample information for the application including a software provider's name 54, a rating 56, a link to customer reviews 58, a download price button 60, and a description of the application 62. The description 62 may indicate the application's purpose, the device requirements for the particular embodiment of the application, and a list of participating entities. The user may review the information and may select to download the application, for example, by pressing the download price button 60.

After downloading the application, the user may create a user profile. FIG. 3C illustrates an example of a user profile 66. In some embodiments, the user profile may be accessed from a user configuration menu 64, and it may include a user name, a street address (e.g., a home address or a business address), an email address, and/or an application password. The application password may be a password for accessing the application, and it may be configured to be verified by any suitable node, such as the device 12 itself or the gateway 14. Verifying the application password at the gateway 14 may reduce the likelihood of the application being accessed if the device 12 becomes lost or stolen.

In some embodiments, the user may press a registration button 64 to instruct the device 12 to send the completed user profile 66 to the gateway 14. The gateway 14 may register the user profile 66 and may store the registered profile in a database that may be accessed during subsequent funds transfers. Accordingly, the user need not re-enter the information for each funds transfer.

The method may require activating the user profile 66 prior to the first transaction. In some embodiments, the gateway 14 may send an activation key to the user for activating the registered user profile 66. For example, the activation key may be sent to the email address indicated by the user profile. The activation key may include one or more security features. As an example, the activation key may expire after a relatively short period of time.

To activate the user profile 66, the user may create an activation request including the application password and the activation key 70, as shown in FIG. 3D. The user may instruct the device 12 to send the activation request to the gateway by pressing an activation button 72. In some embodiments, the device 12 may include the GPS coordinates of its current location in the activation request. The gateway 14 may authorize the device 12 by verifying the application password, the activation key 70, and/or the GPS coordinates. In some embodiments, the GPS coordinates may be compared to the street address indicated by the user profile 66. The registration may be activated if the GPS coordinates substantially match the street address, for example, if the GPS coordinates are within 100 feet of the street address. The gateway 14 may be configured to consider a margin of error of the location technology when determining if the coordinates substantially match.

In some embodiments, the user may access an accounts configuration menu to setup one or more accounts for making and/or receiving payments, performing balance inquiries, or any other suitable function. FIG. 3E illustrates an example accounts configuration menu 74 wherein the user may first select an account type 76 to be configured. Examples of account types may include savings accounts, checking accounts, credit card accounts, debit card accounts, stored value cards, lines of credit, mobile credit accounts, and/or any other suitable account.

FIG. 3F illustrates an example for configuring a new checking account, however, any type of account may be configured. The user may enter account information, such as a bank identifier and a checking account number. For credit card, debit card, stored value card, and/or gift card configurations (not shown), account information may include a card number, an expiration date, and a card security code, such as a Card Verification Value (CVC) 2 code. In addition to the type-specific account information, each account may be configured with an account password. During a transaction, the account password may be verified by any suitable node, such as the device 12 itself or the gateway 14. Verifying the account password at the gateway 14 may reduce the likelihood of the account being accessed if the device 12 becomes lost or stolen. In some embodiments, the account configuration may include information to be passed through the gateway 14 to an account manager, such as a login name and a bank password for accessing a website of the user's bank.

In some embodiments, the user may configure the application to access multiple accounts. A default configuration menu 78 may be used to select preferred accounts for certain transactions. FIG. 3G illustrates an example of default settings. The user may select the default account(s) for making payments 80 as well as the default account(s) for receiving payments 82. In some embodiments, the user may select more than one default account for making or receiving payments. For example, the user may select to pay personal expenses from a checking account and to pay business expenses from a credit card account.

In some embodiments, setting up the device includes receiving one or more authorization codes for authorizing the first transaction of the device 12. Upon completing the setup method, the device 12 may be used to transfer funds.

Modifications, additions, or omissions may be made to the previously described method without departing from the scope of the disclosure. The method may include more, fewer, or other steps. For example, in some embodiments the P2P Payment application 52 may be downloaded directly from a bank's website. The bank's website may transfer an existing user profile 66 and account information to the gateway 14 without requiring the user to separately configure, register, and/or activate the application. Alternatively, the registration and/or activation may be done offline through a call center of the bank or a file feed from a participating bank to an administrator of the gateway 14. As another example, in some embodiments the user may be required to re-register periodically and/or after modifying the user profile 66. In some embodiments, the user may deactivate the registration using a website or call center of the bank or the gateway 14. The user may choose to deactivate the registration if the device 12 becomes lost or stolen.

In some embodiments, the registration and activation procedures may be included in a multi-factor authentication procedure to increase security as compared to known multi-factor authentication procedures. Multi-factor authentication may be used to verify the identity of a person or other entity requesting access to an account. As an example, known procedures for activating a credit card account may typically include three authentication factors: the person activating the credit card account may be required to 1) possess a physical credit card that identifies the account number, 2) call the credit card company from a home phone number associated with the account, and 3) know something, such as personal information describing the account holder (e.g., social security number or mother's maiden name). Embodiments of the present disclosure may include highly secure factors in the multi-factor authentication procedure: the person activating a device 12 may be required to 1) possess the physical device, 2) provide the activation key, and 3) be at a particular location, such as a home address, which may be verified according to GPS coordinates. Additional factors may also be included to increase security. For example, the person may be required to provide personal information or a mailed password, such as a password that has been mailed to a mailing address associated with the account holder. In general, increasing the number of factors and/or the orthogonality of the factors used in multi-factor authentication increases security.

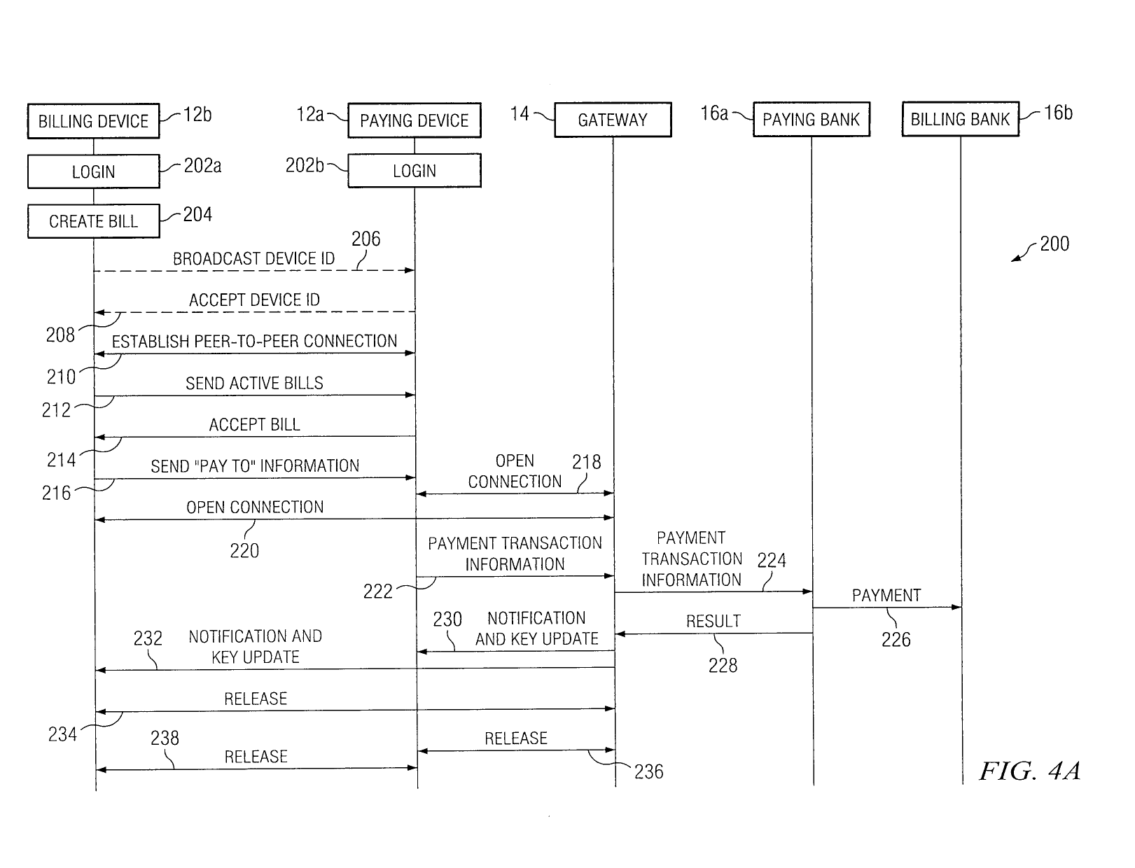

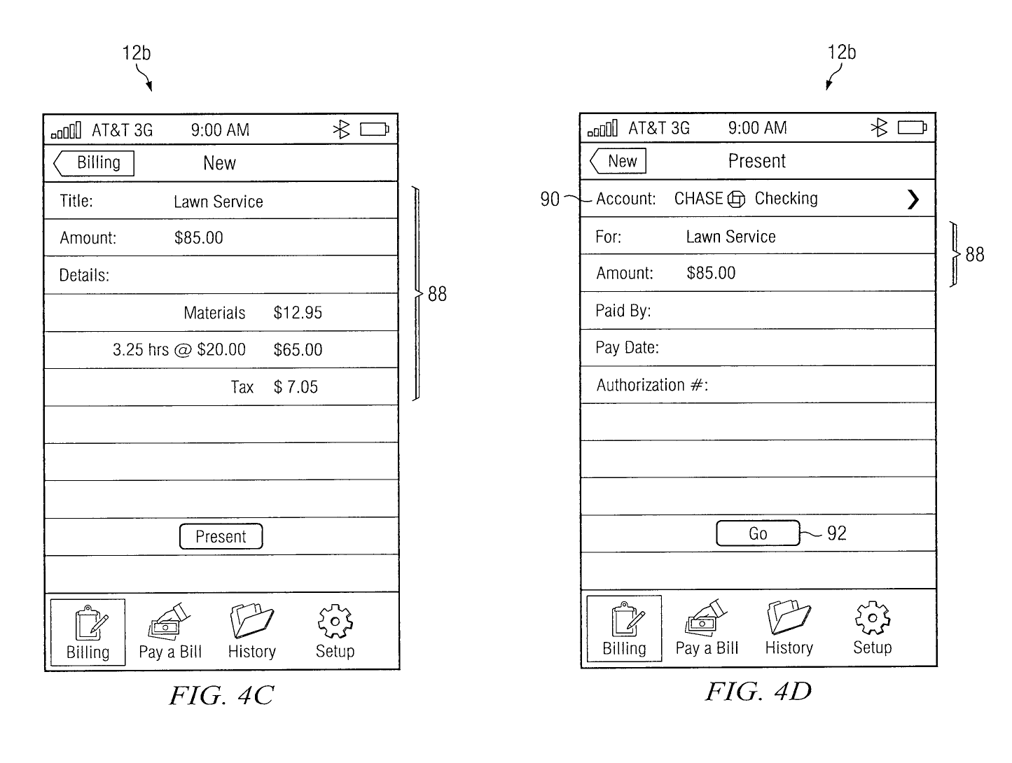

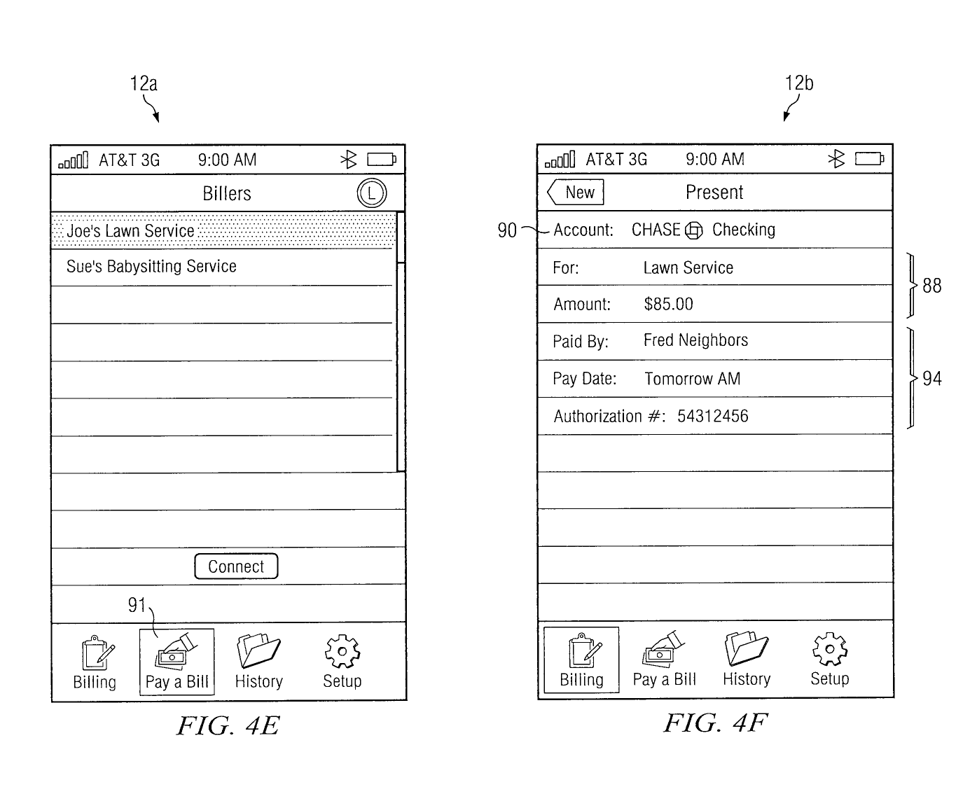

FIGS. 4A-4F illustrate an example method for transacting a secure funds transfer. The method may begin at step 202 where a user launches the funds transfer application and performs a login procedure. The application may be launched from an application menu of the device 12, from a bank's website, or any other suitable source. The login procedure may prompt the user to enter an application password to access the application. In some embodiments, a user of a billing device 12b and a user of a paying device 12a may login to their respective devices 12 at approximately the same time.

The user of the billing device (i.e., the biller) may create a bill at step 204. For example, the biller may access a billing menu 84 of the application as shown in FIG. 4B. The billing menu 84 may allow the biller to create a new bill by pressing an add bill button 86 or to edit an existing bill by selecting the existing bill from a list (not shown). FIG. 4C illustrates an example of a bill 88. In some embodiments, the bill may include a title, a payment amount, and details. The details may provide an itemized record describing the goods and/or services provided, the taxes charged, and any other suitable details. The biller may then select an account for receiving the funds 90, as shown in FIG. 4D. Once the bill is complete, the biller may instruct the device 12b to send the bill by pressing a send button 92.

At step 206, the billing device 12b may broadcast a device identifier. In some embodiments, the device identifier may be broadcast locally over a short-range wireless communication protocol, such as a BLUETOOTH protocol. The device identifier may include a hardware identifier and/or a user-readable name that identifies the device 12b. As an example, “Joe's Lawn Service” may be a user-readable name.

In some embodiments, the user of the paying device (i.e., the payer) may access a list of device identifiers being broadcast nearby, for example, by selecting a menu for paying a bill 91. FIG. 4E illustrates an example where the paying device sees device identifiers from Joe's Lawn Service and Sue's Babysitting Service. As an example, a payer named Fred may owe a payment to Joe's Lawn Service. Accordingly, Fred may instruct the paying device 12a to accept Joe's Lawn Service. At step 208, the paying device 12a may broadcast an accept message. The accept message may include instructions for connecting to the paying device 12a and the device identifier of the billing device 12b. In some embodiments, the accept message includes the hardware identifier of the billing device 12b, but does not include the user-readable name.

Upon receiving the accept message containing the connection instructions and its own device identifier, the billing device 12b may establish a dedicated peer-to-peer connection with the paying device 12a at step 210. The dedicated connection may be established according to the short-range wireless communication protocol being used. Upon establishing the dedicated connection, the paying device 12a and the billing device 12b stop broadcasting the messages associated with the funds transfer.

At step 212, the billing device 12b may send a list of one or more active bills 88 to the paying device 12a. The payer may select the bill 88 to be paid according to the title, payment amount, and/or details. The paying device 12a accepts the bill 88 selected by the payer at step 214. Once the bill 88 has been selected the payer selects an account for making the payment. In some embodiments, the payer may be prompted to enter an account password to login to the account.

Upon receiving the accept bill message, the billing device 12b may send “Pay To” information to the paying device 12a, as shown in step 216. The Pay To information may include the device identifier of the billing device, the location of the billing device, a bill number, the bill title, the payment amount, the bill details, and/or one or more authorization codes. In some embodiments, the authorization codes may include a biller authorization code representing a user name of the biller and a biller account code representing the account to which the funds are to be transferred.

At steps 218 and 220, each device 12 may open a connection with the gateway 14. The connections may be opened according to any suitable network communications protocol. The connections may be secured by any suitable security protocol, such as Secure Socket Layer (SSL) 5.

The paying device 12a may send a transaction to the gateway 14 at step 222. The transaction may include the Pay To information and “Bill To” information describing the paying device 12a. In some embodiments, the paying device 12a may include only certain parameters of the Pay To information, such as the device identifier of the billing device, the location of the billing device, the bill title, the payment amount, and the authorization codes, without including other parameters, such as the bill number and bill details. The Bill To information may include the device identifier of the paying device, the location of the paying device, one or more authorization codes, and login information for accessing the payer's account manager (e.g., bank password). The authorization codes may include a payer authorization code representing a user name of the payer and a payer account code representing the account from which the funds are to be withdrawn.

Upon receipt of the transaction, the gateway 14 may perform one or more authorization procedures. In some embodiments, the gateway 14 may compare the location of the billing device 12b to the location of the paying device 12a to determine a distance between the devices 12. For example, the gateway 14 may compare the GPS coordinates of the devices 12. The gateway 14 may authorize the transaction if the distance between the devices 12 is less than a maximum allowed distance, such as less than 100 feet, for example, less than 2 feet. The gateway 14 may consider the margin of error of the location technology when determining whether the distance is less than the maximum allowed distance.

In some embodiments, the gateway 14 may authorize the transaction according to the authorization codes. For example, the gateway 14 may access a plurality of valid codes for the devices. The valid codes may be available from any suitable location such as the memory of the gateway 14 or a database of the network. The gateway 14 may compare each authorization code to its corresponding valid code to confirm that the codes match. If the codes do not match, the authorization may fail and the transaction may be blocked.

If the authorization is successful, the gateway 14 may determine the paying account and the billing account according to the authorization codes. That is, the gateway 14 may determine the confidential information represented by the authorization codes. In some embodiments, the accounts may be determined using a lookup table that maps the authorization codes to the confidential information. In some embodiments, the confidential information may be calculated using an algorithm to process the authorization codes. The gateway 14 may then use the confidential information to determine the account managers 16 for the paying account and the billing account.

At step 224, the gateway 14 may instruct the payer's account manager 16a (e.g., the paying bank) to withdraw the payment amount from the paying account and to deposit the payment amount into the billing account. In some embodiments, the instructions may include a minimal amount of information needed to complete the transaction. For example, the instructions may include the payer's user name and account number, the biller's user name, bank number, and account number, the bill title, the payment amount, and the payer's password for accessing the payer's account (e.g., the bank password). Minimizing the amount of information sent in the instructions may reduce the complexity of the transaction as well as the amount of resources required to support the transaction. In some embodiments, the paying bank 16a may confirm that the password is correct and that the account has sufficient funds for the transaction.

In some embodiments, a payee of the account manger 16a may be created dynamically, and the payee may be discarded at the end of the transaction. As an example, to create a payee a bank may require the name of the payee, such as “Electric Company,” the payer's account number with the payee, such as an account number identified on an electric bill, and other suitable information. In known systems, a user may manually create payees by logging on to the bank's website and providing the required information. The information may be stored on the bank's system until the user manually deletes the payee to prevent subsequent payments to the deleted payee. Because deleting the payee depends on the user, the bank website may store information about the payee for a relatively long time. By contrast, in certain embodiments, the gateway 14 may provide the information required to create a new payee to the account manager 16a during the transaction. At the end of the transaction, the account manager 16a may delete the payee. The payee may be recreated (and then deleted) during a subsequent transaction if the payer wishes to make another payment to the particular payee.

In step 226, the paying bank 16a may make the payment to the billing bank 16b according to the instructions. The paying bank 16a may make the payment using an ACH or two-day ACH funds transfer, a check, or any other form of payment.

At step 228, the gateway 14 may receive the result of the transaction from the paying bank 16a. The result may indicate whether the transaction succeeded, a transaction number, and/or an estimated date that the transferred funds will become available to the biller. In some embodiments, the result may include a link, such as a link to a Uniform Resource Locator (URL) address, for tracking the status of the funds transfer.

In some embodiments, the gateway 14 may notify the paying device 16a of the result at step 230 and may notify the billing device 16b of the result at step 232. Sending the result to the billing device 16b from the gateway 14, rather than from the paying device 16a, may reduce the risk of fraud. For example, the paying device 16a may not be able to alter the notification that the billing device 16b receives. The result may be communicated to the user via email, text message, or any suitable type of notification. An example of a result 94 received by the billing device 12b is illustrated in FIG. 4F.

In some embodiments, the method may include generating a plurality of updated valid codes and a plurality of authorization codes corresponding to the updated valid codes. The updated valid codes may be available to the gateway 14 for verifying subsequent transactions. The gateway 14 may send a first subset of updated authorization codes to the paying device 12a to be used in its next transaction and a second subset of updated authorization codes to the billing device 12b to be used in its next transaction. In some embodiments, the updated authorization codes may be sent with the notification message. The updated authorization codes may be sent to the device 12 to be stored in memory and automatically entered into the application during the next transaction. To minimize the risk of fraud, the authorization codes may remain hidden such that a user may not view them.

At step 234, the connection between the gateway 14 and the billing device 12b is released. At step 236, the connection between the gateway 14 and the paying device 12a is released. At step 238, the local communication connection between the billing device 12b and the paying device 12a is released and the method ends.

Modifications, additions, or omissions may be made to the previously described method without departing from the scope of the disclosure. The method may include more, fewer, or other steps. For example, connections between the nodes may be opened and released at any suitable time. In some embodiments, the connection between the billing device 12b and the paying device 12a may be released once the Pay To information has been received by the paying device 12a. As another example, the notification and the authorization code update may be sent to a device 12 in separate messages. In some embodiments, updates to the authorization codes and/or the transaction status may be initiated by the gateway 14 using a Short Message Service (SMS) Push message. The SMS Push message may cause a device that is not running the P2P Payment application to open the application so that the update may occur. As an example, a billing device 12b may become disconnected from the gateway 14 during a transaction. Reasons for the disconnection may include inadequate wireless signal coverage or interruption by another service, such as an incoming phone call. The gateway 14 may determine that communication with the billing device 12b has been disconnected and may send any missed notifications to the billing device 12b via an SMS Push or any suitable notification means. In some embodiments, a bill may be configured with a notification number so that the gateway 14 may identify the bill and the corresponding device 12 to be notified.

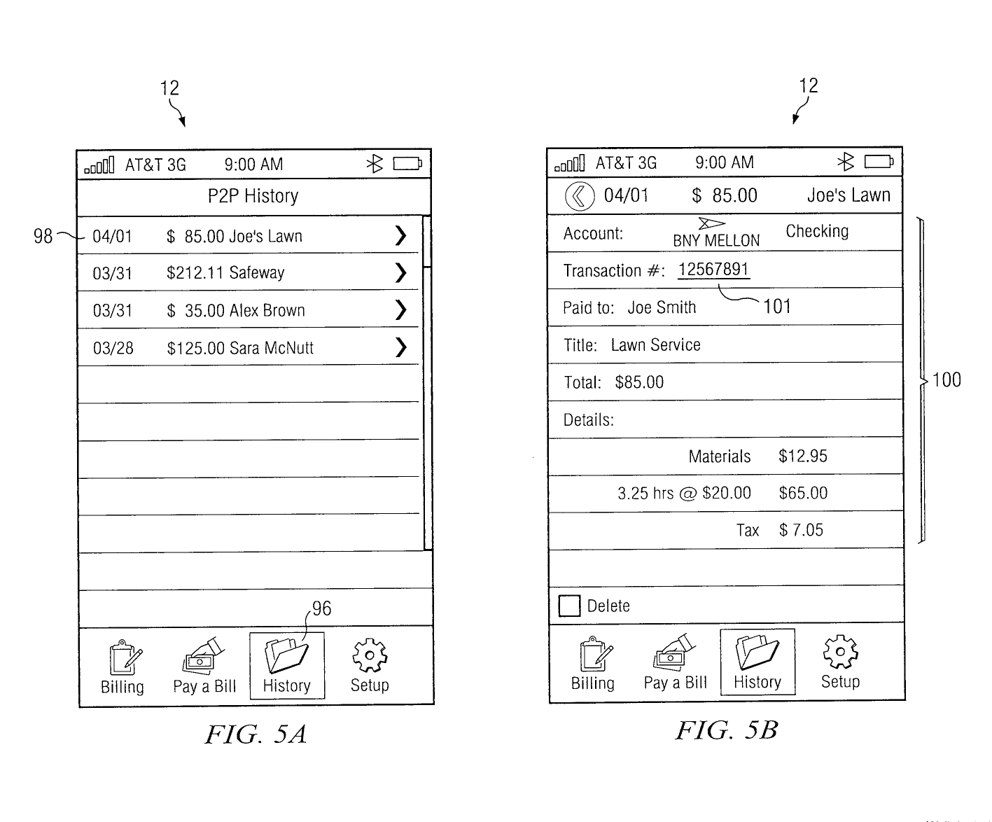

FIGS. 5A-5B illustrate an example of an archive for tracking pending and completed secure funds transfers. In some embodiments, a P2P Payment application may include a history menu 96 allowing a user to view completed transactions, to manually or periodically delete completed transactions from the archive, and to download completed transactions to another computer. FIG. 5A illustrates an example of an archive list comprising list entries 98 to identify transactions according to date, payment amount, and/or the name of the other party. FIG. 5B illustrates an example wherein the list entries 98 may be expanded to provide additional details 100, such as the itemized bill, the account used for the transaction, and/or a transaction number. In some embodiments, the archive may include a transaction link 101 to the account manager's website for viewing a current status of the transaction.

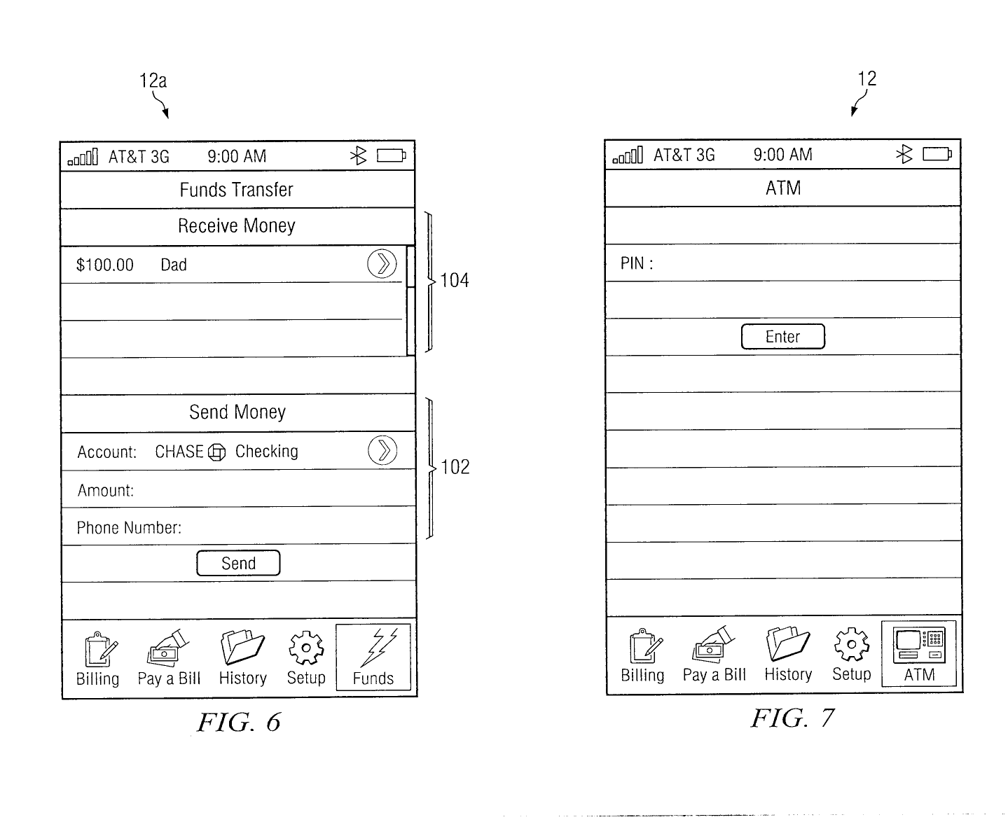

FIG. 6 illustrates an example of a secure funds transfer that may be completed by the paying device 12a alone. In the embodiment, the paying device 12a may transfer funds to a remotely located billing device 12b. The user of the paying device 12a may access a paying account 102 and may indicate a billing account 104 for receiving the funds. In some embodiments, the billing account 104 may be pre-configured as a “trusted” account. For example, the billing account 104 may be an account belonging to a friend or family member of the user. As another example, the billing account 104 may be another account of the user. In some embodiments, an authorization procedure may be used to initially configure an account of the billing device 12b as a trusted account. The authorization procedure may include verifying the location and the authorization codes of the billing device. Configuring an account as trusted may allow certain aspects of the authorization procedure, such as proximity-based authorization, to be bypassed during subsequent transactions.

FIG. 7 illustrates an example of an ATM interface for transacting a secure funds transfer. The ATM interface may eliminate the need to swipe a debit card through the machine and may thus prevent fraud, such as skimming of account numbers and Personal Identification Numbers (PINs). In some embodiments, the ATM may be configured to receive a transaction from a device 12, via local communication, and route the transaction to the gateway 14. The transaction may include the GPS coordinates of the device 12, and the gateway 14 may compare the GPS coordinates to the address of the ATM during the authorization procedures.

While the present invention has been described in detail with reference to particular embodiments, numerous changes, substitutions, variations, alterations and modifications may be ascertained by those skilled in the art, and it is intended that the present invention encompass all such changes, substitutions, variations, alterations and modifications as falling within the spirit and scope of the appended claims.

What is claimed is:

1. A method, comprising:
receiving at a gateway a transaction from a first device, the first device in local communication with a second device, the transaction including:
a payment amount; and
a plurality of authorization codes configured to represent confidential information of the first device and the second device;
authorizing the transaction, the authorizing including verifying the plurality of authorization codes;
determining a first account and a second account according to the authorization codes, the first account associated with the first device and managed by an account manager, the second account associated with the second device;
instructing the account manager to withdraw the payment amount from the first account and to deposit the payment amount into the second account;
receiving a result from the account manager; and
sending the result to the first device and the second device.

2. The method of claim 1, further including:
configuring the first device and the second device as mobile devices, and
configuring the local communication according to a secure short-range wireless communication protocol.

3. The method of claim 1, further including:
configuring the first device and the second device as mobile devices, and
configuring the local communication according to a BLUETOOTH protocol.

4. The method of claim 1, further including:
configuring the first device and the second device as mobile devices, and
configuring the local communication according to a Near Field Communication (NFC) protocol.

5. The method of claim 1, further including:
configuring the second device as an Automatic Teller Machine (ATM).

6. The method of claim 1, wherein:
the receiving the transaction from the first device includes receiving a location of the first device and a location of the second device; and
the authorizing the transaction includes determining a distance from the location of the first device to the location of the second device and confirming the distance is less than a maximum allowed distance.

7. The method of claim 1, wherein:
the receiving the transaction from the first device includes receiving a location of the first device and a location of the second device; and
the authorizing the transaction includes determining a distance from the location of the first device to the location of the second device and confirming the distance is less than a maximum allowed distance, the maximum allowed distance ranging from 2 to 100 feet.

8. The method of claim 1, wherein:
the receiving the transaction from the first device includes receiving Global Positioning System (GPS) coordinates indicating a location of the first device and a location of the second device; and
the authorizing the transaction includes determining a distance from the location of the first device to the location of the second device and confirming the distance is less than a maximum allowed distance.

9. The method of claim 1, wherein the plurality of authorization codes include:
a payer authorization code representing a user name of a payer making a payment with the first device;
a payer account code representing the first account;
a biller authorization code representing a user name of a biller receiving a payment with the second device; and
a biller account code representing the second account.

10. The method of claim 1, further including:
generating a plurality of updated authorization codes;
sending a first subset of the plurality of updated authorization codes to the first device, the first subset of updated authorization codes operable to verify a next transaction of the first device; and
sending a second subset of the plurality of updated authorization codes to the second device, the second subset of updated authorization codes operable to verify a next transaction of the second device.

11. The method of claim 1, further including:
receiving a registration request at the gateway prior to receiving the transaction, the registration request received from the first device, the registration request including a user profile including a street address and an email address of a user;
registering the user profile with the gateway;
sending an activation key to the email address indicated by the user profile;
receiving an activation request from the first device at the gateway, the activation request requesting to activate the user profile and including the activation key and GPS coordinates indicating a location of the first device; and
activating the user profile if:
the activation key received in the activation request matches the activation key sent to the email address; and
the GPS coordinates substantially match the street address received in the user profile.

12. The method of claim 1, wherein:
the receiving the transaction from the first device includes receiving a password configured to access the first account; and
the instructing the account manager to withdraw the payment amount includes sending the password to the account manager.

13. The method of claim 1, wherein:
the verifying the plurality of authorization codes further includes:
accessing a plurality of valid codes;
comparing the plurality of authorization codes to the plurality of valid codes;
confirming that each authorization code of the plurality of authorization codes matches a corresponding valid code of the plurality of valid codes; and
generating a plurality of updated authorization codes by:
replacing the plurality of valid codes with a plurality of updated valid codes, the updated valid codes including a first subset of updated valid codes configured to verify the next transaction of the first device and a second subset of updated valid codes configured to verify the next transaction of the second device;
determining a first subset of updated authorization codes according to the first subset of updated valid codes;
determining a second subset of updated authorization codes according to the second subset of updated valid codes; and
sending the first subset of updated authorization codes to the first device and the second subset of updated authorization codes to the second device.

14. The method of claim 1, wherein the first account is selected from the group consisting of:
a savings account;
a checking account;
a credit card account;
a debit card account;
a stored value card;
a line of credit; and
a mobile credit account.

15. The method of claim 1, further comprising:
receiving a registration request at the gateway prior to receiving the transaction, the registration request received from the first device, the registration request including a user profile including an address of a user;
registering the user profile with the gateway;
receiving an activation request from the first device at the gateway, the activation request requesting to activate the user profile and including GPS coordinates indicating a location of the first device; and
activating the user profile if the GPS coordinates substantially match the address received in the user profile.

16. A system, comprising:
a gateway including one or more interfaces operable to:
receive a transaction from a first device, the first device in local communication with a second device, the transaction including:
a payment amount; and
a plurality of authorization codes configured to represent confidential information of the first device and the second device;
instruct an account manager to:
withdraw the payment amount from a first account associated with the first device and managed by the first account manger; and
deposit the payment amount into a second account associated with the second device;
receive a result from the account manager; and
send the result to the first device and the second device; and
the gateway further including one or more processors operable to:
authorize the transaction, the authorizing including verifying the plurality of authorization codes; and
determine the first account and the second account according to the authorization codes.

17. The system of claim 16. further including:
the one or more processes further operable to generate updated authorization codes, the updated authorization codes including a first subset and a second subsets of updated authorization codes; and
the one or more interfaces further operable to:
send the first subset of updated authorization codes to the first device, the first subset of updated authorization codes operable to verify a next transaction of the first device; and
send the second subset of updated authorization codes to the second device, the second subset of updated authorization codes operable to verify a next transaction of the second device;

18. Logic encoded on a computer readable medium and operable to:
receive at a gateway a transaction from a first device, the first device in local communication with a second device, the transaction including:
a payment amount; and
a plurality of authorization codes configured to represent confidential information of the first device and the second device;
authorize the transaction, the authorizing including verifying the plurality of authorization codes;
determine a first account and a second account according to the authorization codes, the first account associated with the first device and managed by an account manager, the second account associated with the second device;
instruct the account manager to withdraw the payment amount from the first account and to deposit the payment amount into the second account;
receive a result from the account manager; and
send the result to the first device and the second device.

19. The logic of claim 18, further operable to:
generate a plurality of updated authorization codes;
send a first subset of the plurality of updated authorization codes to the first device, the first subset of updated authorization codes operable to verify a next transaction of the first device; and
send a second subset of the plurality of updated authorization codes to the second device, the second subset of updated authorization codes operable to verify a next transaction of the second device.

20. A method for multi-factor authentication, comprising:
receiving a plurality of authentication factors from a mobile device, a first authentication factor of the plurality of authentication factors including a location of the mobile device; and
authenticating the mobile device according to the plurality of authentication factors, the authenticating including determining whether the location of the mobile device substantially matches an expected location of the mobile device.

21. The method of claim 20, further comprising:
sending a plurality of authorization codes to the device if the location of the mobile device substantially matches the expected location and the authentication succeeds, the expected location indicated by a user profile of the device, the plurality of authorization codes configured to authorize a transaction of the device.

22. The method of claim 20, wherein:
a second authentication factor of the plurality of authentication factors includes an activation key; and
a third authentication factor of the plurality of authentication factors includes a device identifier, the device identifier identifying the mobile device being authenticated.

23. The method of claim 20, wherein:
a second authentication factor of the plurality of authentication factors includes a mailed password.

24. A method, comprising:
receiving at a gateway a transaction from a first device, the first device in local communication with a second device, the transaction including a payment amount, a location of the first device, and a location of the second device;
authorizing the transaction, the authorizing including determining a distance from the location of the first device to the location of the second device and confirming the distance is less than a maximum allowed distance;
instructing an account manager to:
withdraw the payment amount from a first account associated with the first device and managed by the account manager; and
deposit the payment amount into a second account associated with the second device;
receiving a result from the account manager;
sending the result to the first device and the second device.

25. The method of claim 24, wherein the maximum allowed distance ranges from 2 to 100 feet.

26. The method of claim 24, the location of the first device including Global Positioning System (GPS) coordinates of the first device and the location of the second device including GPS coordinates of the second device.

27. The method of claim 24, further including:
configuring the first device and the second device as mobile devices, and
configuring the local communication according to a secure short-range wireless communication protocol.

28. The method of claim 24, the sending the result to the second device further including:
determining that a disconnection from the second device occurred; and
sending the result to the second device using an SMS Push message.

29. The method of claim 24, the instructing the account manager further including:
instructing the account manager to create a payee for the transaction and to delete the payee upon completion of the transaction.

30. A method, comprising:
establishing, by a first device, local communication with a second device;
receiving Pay To information from the second device;
generating a transaction according to the Pay To information, the transaction including a payment amount and a plurality of authorization codes configured to represent confidential information of the first and the second device;
sending the transaction to a gateway, the gateway configured to:
authorize the transaction, the authorization including verifying the plurality of authorization codes;
determine a first account and a second account according to the authorization codes, the first account associated with the first device and managed by an account manager, the second account associated with the second device;
instruct the account manager to withdraw the payment amount from the first account and to deposit the payment amount into the second account;
receive a result from the account manager; and
receiving the result from the gateway.

31. The method of claim 30, the first device further operable to:
select the second device as a trusted device;
generate a second transaction without establishing local communication with the second device; and
send the second transaction to the gateway, the gateway configured to authorize the second transaction.
